(19) United States
(12) Patent Application Publication
(10) Pub. No.: US 2007/0022476 A1
(43) Pub. Date: Jan. 25, 2007

(54) System and method for optimizing tunnel authentication procedure over a 3G-WLAN interworking system

(75) Inventors: Eun-Hui Bae, Seoul (KR); R. Rajavelsamy, Bangalore (IN)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/454,131

(22) Filed: Jun. 16, 2006

(30) Foreign Application Priority Data
Jun. 16, 2005 (IN) 735/CHE/2005

(51) Int. Cl. G06F 15/16

(52) U.S. Cl. 726/15

(57) ABSTRACT

Provided is a method for optimizing a current tunnel authentication for a 3G-WLAN interworking system that includes a UE, WLAN, PDG and AAA Server, wherein the UE has been previously authenticated by the AAA Server. The method includes intimating the AAA Server to derive a TSK for a current tunnel establishment request.

### CROSS-REFERENCE TO RELATED PATENT APPLICATION

This application claims the benefit under 35 U.S.C. § 119(a) of Indian Provisional Patent Application No. 735/CHE/2005, filed Jun. 16, 2005, in the Indian Intellectual Property Office, the entire disclosure of which is hereby incorporated by reference.

### BACKGROUND OF THE INVENTION

1. Field of the Invention

The present invention relates to a system and method for optimizing a tunnel authentication procedure over a Third Generation Wireless Local Area Network (3G-WLAN) interworking system. More particularly, the present invention relates to a system and method for deriving new keys for Internet Key Exchange version 2 (IKEv2) mutual authentication by using existing valid keys derived during a previous authentication procedure to derive new keys for the subsequent tunnel establishment procedures over a 3G-WLAN interworking system.

2. Description of the Related Art

Standardization work by the 3rd Generation Partnership Project (3GPP) is ongoing for a 3G-WLAN interworking system. A 3G-WLAN interworking system allows for the utilization of resources and access to services within a 3GPP system by user equipment (UE) operating in a 3G-WLAN. The 3G-WLAN interworking system operates by establishing an End-To-End Internet Protocol (IP) tunnel between the UE and 3GPP system through the WLAN.

FIG. 1 is a conceptual diagram of an exemplary WLAN-3G interworking system in which an End-To-End Internet Protocol (IP) tunnel is established. The 3G-WLAN interworking system includes UE 100, WLAN 110 and a Public Land Mobile Network (PLMN) 160. The PLMN 160 includes a Wireless Access Gateway (WAG) 120, Packet Data Gateway (PDG) 130, Authentication, Authorization and Accounting (AAA) Server 140 and Home Subscription Server (HSS) 150. The UE 100 is communicably coupled to WLAN 110 which in turn is communicably coupled to both AAA Server 140 and WAG 120. Both HSS 150 and PDG 150 are communicably coupled to AAA Server 160 and PDG 150 is additionally communicably coupled to WAG 120. An End-To-End IP tunnel 170 is established between UE 100 and PDG 130.

Security for 3G-WLAN interworking is embodied in the 3GPP TS 33.234 specification, the entire disclosure of which is hereby incorporated by reference. FIG. 2 is a diagram illustrating a process for establishing an UE 100 initiated End-To-End IP tunnel 170, as described in 3GPP TS 33.234. In step 200, WLAN Access Authentication and Authorization and WLAN UE local IP address allocation occurs. In step 210, the UE 100 initiates WLAN Access Point Name (W-APN) resolution and tunnel establishment with PDG 130. Step 210 will now be described in greater detail including substeps 211-214.

In step 211, UE 100 performs a Domain Name Server (DNS) query to resolve the W-APN. The DNS response contains one or more IP addresses of equivalent PDGs 130 that support the requested W-APN in the PLMN 160, according to conventional DNS procedures. If the PLMN 160 does not support the W-APN, then the DNS query returns a negative response. In step 212, UE 100 selects a PDG 130 from the list received in step 211. An End-To-End IP tunnel is then established between UE 100 and the selected PDG 130. The UE 100 includes the W-APN and the user identity of the EU 100 in the initial tunnel establishment request. In step 213, PDG 130 contacts the AAA Server 140 for authentication of the UE 100 and authorization of the requested service. After successful authentication, the AAA Server 140 passes key information to the PDG 130 to establish Security Associations (SAs) with the UE 100. In step 214, PDG 130 and WAG 120 exchange information via the AAA Server 140 in order to establish a filtering policy to allow the forwarding of tunneled packets to the PDG 130.

Tunnel establishment procedures are provided in current 3GPP systems, as embodied in the 3GPP TS 33.234 and other related specifications. Currently, IKEv2 is used to dynamically establish IP Security Protocol (IPSec) SAs between the UE 100 and the PDG 130. IKEv2 mandates mutual authentication between peers. For IKEv2 mutual authentication in a 3G-WLAN interworking scenario, the PDG 130 uses a public key certificate to authenticate to the UE 100, while UE 100 uses an Extensible Authentication Protocol Method for UMTS Authentication and Key Agreement (EAP-AKA) to authenticate to the PDG 130. As a result, the procedure requires a minimum of six messages between UE100 and PDG 130 and four additional messages between PDG 130 and AAA Server 140 to perform Internet Key Exchange Authentication (IKE_AUTH) within IKEv2.

The excessive number of message exchanges in combination with public key cryptographic computation imposes heavy burdens on both devices and network traffic for subsequent tunnel establishment.

Accordingly, there is a need for a system and method for optimizing a tunnel authentication procedure over a Third Generation Wireless Local Area Network (3G-WLAN) interworking system that has a reduced number of message exchanges.

### SUMMARY OF THE INVENTION

Exemplary embodiments of the present invention address at least the above problems and/or disadvantages and provide at least the advantages described below. Accordingly, an aspect of the present invention is to optimize the subsequent tunnel authentication procedure in a 3G-WLAN interworking environment.

Accordingly, an exemplary aspect of the present invention is to provide method for optimizing a current tunnel authentication for an interworking system comprising a UE, WLAN, PDG and AAA Server, wherein the UE has been previously authenticated by the AAA Server. The method includes intimating the AAA Server to derive a Tunnel Session Key (TSK) for a current tunnel establishment request.

Another exemplary aspect of the present invention is to provide the method wherein the TSK is derived using an Extended Master Session Key (EMSK) derived during the previous authentication.

Yet another exemplary aspect of the present invention is to provide the method wherein the previous authentication is a prior tunnel authentication or a prior WLAN access authentication that was not performed for a current tunnel establishment request.

A further exemplary aspect of the present invention is to provide the method wherein the TSK is derived after the current tunnel authentication begins.

An additional exemplary aspect of the present invention is to provide the method wherein upon deriving the TSK, the AAA Server sends the TSK to the PDG.

Another exemplary aspect of the present invention is to provide the method wherein the previous authentication is a WLAN access authentication performed for a current tunnel establishment request.

Still another exemplary aspect of the present invention is to provide the method wherein the TSK is derived after the WLAN access authentication but before current tunnel authentication begins.

Yet another exemplary aspect of the present invention is to provide the method wherein upon deriving the TSK, the AAA Server stores the TSK.

A further exemplary aspect of the present invention is to provide the method wherein the AAA Server sends the TSK to the PDG after the current tunnel authentication begins.

An additional exemplary aspect of the present invention is to provide the method wherein the UE sends an authentication request message to the PDG comprising an Authentication (AUTH) payload that is calculated using a UE derived TSK.

Another exemplary aspect of the present invention is to provide the method wherein the UE intimates the PDG to use a TSK by including a Notify payload or Vendor Identification (ID) payload in the authentication request message.

A further exemplary aspect of the present invention is to provide the method wherein the PDG, after receiving the authentication request message, sends an access request message to the AAA Server so as to request the TSK.

Still another exemplary aspect of the present invention is to provide the method wherein the access request message comprises a new Diameter/Radius AVP or the Vender ID AVP of a Diameter/Radius so as to intimate the AAA Server.

An additional exemplary aspect of the present invention is to provide the method wherein the AAA Server, after receiving the access request message, sends an access accept message to the PDG, the Access Accept message comprising the derived TSK. The PDG, using the TSK, verifies the AUTH payload sent by the UE and calculates the AUTH payload using a certificate. The PDG sends an authentication response message to the UE, the authentication response message comprising the AUTH payload. The UE receives the authentication response message, verifies the AUTH payload using the certificate and establishes an IPSec SA.

An additional exemplary aspect of the present invention is to provide the method wherein the WLAN access authentication, the UE sends an EAP message to the WLAN that is relayed to the AAA Server, wherein the EAP message comprises piggy-backed Packet Switched (PS) service information or an extended payload so as to intimate the current tunnel establishment request.

A further exemplary aspect of the present invention is to provide the method wherein during the WLAN access authentication, the UE sends an EAP message to the WLAN that is relayed to the AAA Server, wherein the AAA Server checks to see if UE is associated with an interworking WLAN subscriber, and if so the AAA Server sends a notification request that is relayed by the WLAN to the UE, wherein the notification request is at least partially used for determining if there is a current tunnel establishment request.

Still another exemplary aspect of the present invention is to provide the method wherein the UE, upon receiving the notification request, sends a notification response message that is relayed via the WLAN or the AAA Server so as to intimate the current tunnel establishment request.

An additional exemplary aspect of the present invention is to provide a system for optimizing a current tunnel authentication. The system includes an interworking system comprising a UE, WLAN, PDG and AAA Server, wherein the UE has been previously authenticated by the AAA Server, and further wherein the AAA Server is intimated to derive a TSK for a current tunnel establishment request.

Yet another exemplary aspect of the present invention is to provide the system wherein the previous authentication comprises at least one of a prior tunnel authentication and a prior WLAN access authentication not performed for a current tunnel establishment request.

A further aspect of the present invention is to provide the system wherein the previous authentication comprises a WLAN access authentication performed for a current tunnel establishment request.

An additional exemplary aspect of the present invention is to provide the system wherein the TSK is derived using an EMSK derived during the previous authentication.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a conceptual diagram of an exemplary WLAN-3G interworking system in which an End-To-End IP tunnel is established.

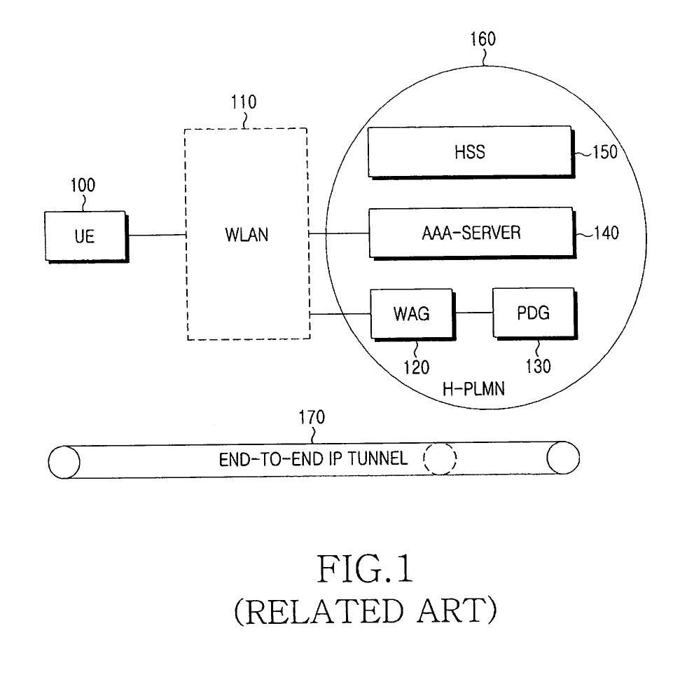

FIG. 2 is a diagram illustrating a process for establishing an UE initiated End-To-End IP tunnel, as described in 3GPP TS 33.234.

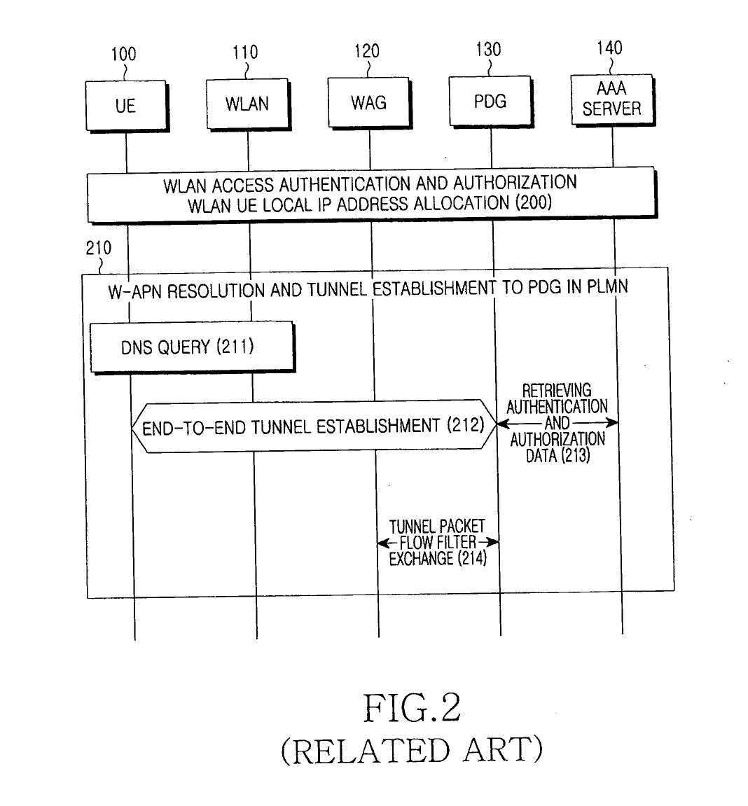

FIG. 3 a diagram illustrating message exchanges, according to an exemplary embodiment of the invention, using a TSK with the messages exchanged between the UE and the AAA Server via the PDG during the tunnel establishment procedure.

FIG. 4 is a diagram illustrating message exchanges, according to an exemplary embodiment of the invention, between the UE and the AAA Server when accessing the “WLAN 3GPP IP Access” services after “WLAN Direct IP Access” authentication.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide for the generation of optimized IKEv2 mutual authentication keys for tunnel establishment over a 3G-WLAN interworking system. Further, exemplary embodiments of the present invention provide a process by which the UE intimates the AAA Server to derive the TSK for IKEv2 mutual authentication by using an EMSK derived during the previous authentication procedure, for the tunnel establishment request. Additionally, exemplary embodiments of the present invention provide a mechanism for deriving the TSK by using the EMSK derived during the previous authentication procedure for the subsequent tunnel establishments over a 3G-WLAN interworking system. Preferably, exemplary embodiments of the present invention utilize a 3G-WLAN UE that establishes multiple End-To-End IP tunnels towards the PDG over a 3GPP specified interface. During the tunnel establishment procedure, the AAA Server will generate new keys without performing the full authentication procedure or fast authentication procedure, provided that the UE is already authenticated and the derived keys are valid. The parameters used in generating the TSK are:

TSK = prf{EMSK, W-APN, Length of the Key}

or alternatively

TSK = prf{EMSK, “W-APN”, Identity, Length of the Key)}

Where:

| | |
|---|---|
| Prf | Pseudo random generator agreed between the UE and the |
| | AAA Server during the previous EAP-Subscriber Identity |
| | Module (SIM) or EAP-AKA authentication procedure. |
| EMSK | Extended Master Session Key generated by the UE and |
| | AAA Server during previous authentication procedure. |
| W-APN | WLAN Access Point Name included in the tunnel request |
| | message. |
| Identity | User identity included in the tunnel request message. |
| Length of | Output length of the TSK key. |
| the Key | |

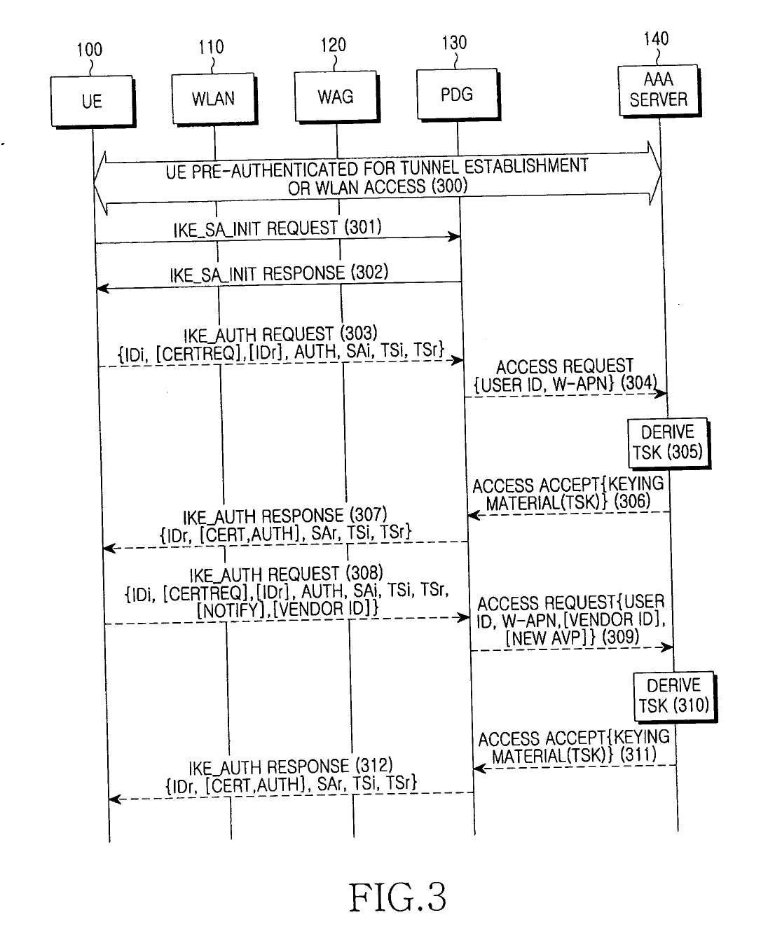

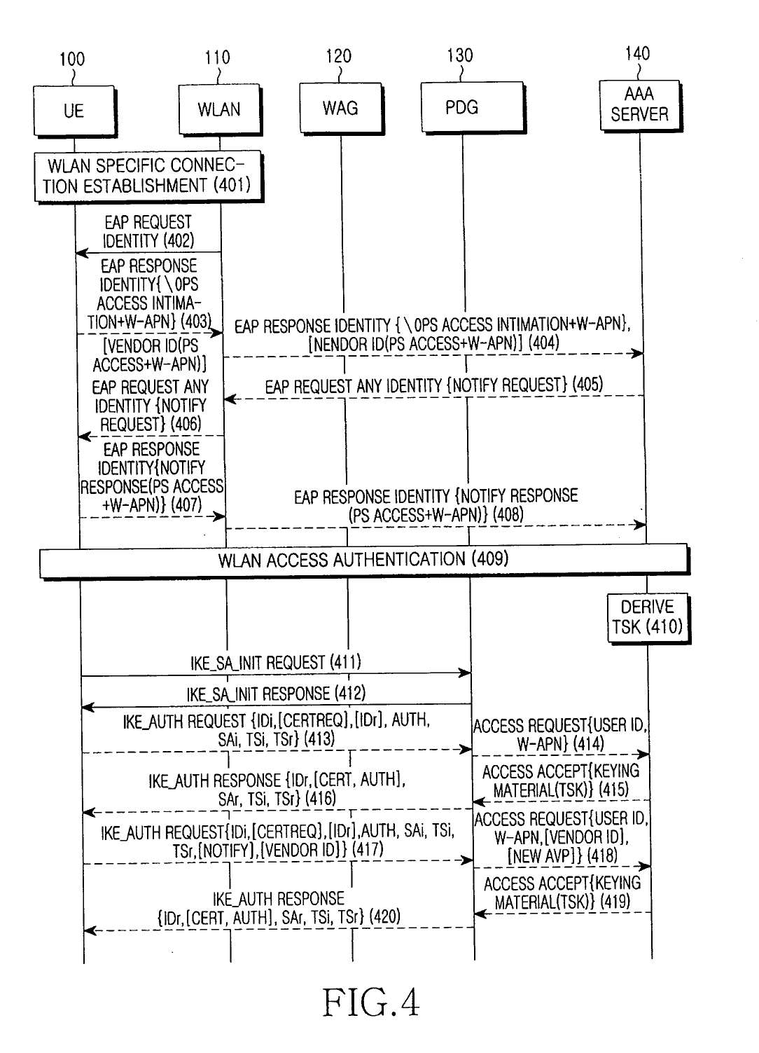

When a 3G-WLAN UE sends a request for tunnel establishment towards the PDG, it may intimate the AAA Server to use a TSK, this scenario can be considered in two cases. In the first case, the AAA Server is intimated to derive and use the TSK during subsequent tunnel establishment requests. In the second case, intimation of PS access occurs during the “WLAN Direct IP Access” authentication (WLAN access authentication) to the AAA Server, so as to derive the TSK immediately. The first and second cases will be described below in greater detail by referring to FIG. 3 and FIG. 4 respectively.

FIG. 3 is a diagram illustrating message exchanges, according to an exemplary embodiment of the invention, using a TSK with the messages exchanged between the UE and the AAA Server via the PDG during the tunnel establishment procedure. In FIG. 3, the AAA Server is intimated in order to derive and use the TSK during subsequent tunnel establishment requests. In step 300, the AAA Server 140 has previously authenticated the UE 100 during a prior Tunnel establishment or WLAN Access.

In step 301 UE 100 sends an Initial Internet Key Exchange security association (IKE_SA_INIT) request to PDG 130 and in step 302 UE 100 receives an IKE_SA_INIT response from PDG 130. Thereby in steps 301 and 302, the UE 100 and the PDG 130 negotiate an IKE_SA.

In step 303 the UE 100 may directly derive a TSK and use it to calculate the AUTH. Here, the UE 100 includes the AUTH payload within the Internet Key Exchange Authentication (IKE_AUTH) request message and sends it to the PDG 130. The IKE_AUTH request message may further include an Identification-Initiator (IDi), Certificate Request ([CERTREQ]), Security Association-Initiator (SAi), Traffic Selector-Initiator (TSi) and Traffic Selector-Responder (TSr).

In step 304, after PDG 130 receives the IKE_AUTH request message from UE 100 with AUTH payload, the PDG 130 requests that the AAA Server 140 derive the TSK, if the UE 100 has been previously authenticated. The request is via an Access Request message sent from PDG 130 to AAA Server 140. The Access Request message may include a User Identification (ID) and a W-APN. In step 305, after the AAA Server 140 receives the Access Request message from the PDG 130, the AAA Server 140 then derives the TSK, if the UE 100 has been previously authenticated. In step 306, the AAA Server 140 passes the TSK to the PDG 130 through an Access Accept message. The Access Accept message may include keying material which may include the TSK.

In step 307, the PDG 130 using the TSK, verifies the AUTH Payload sent by the UE 100 and calculates the AUTH payload using a certificate. Then the PDG 130 sends the IKE_AUTH response message including the AUTH payload to the UE 100. The IKE_AUTH response message may further include an Identification-Responder (IDr), Certificate ([CERT]), Security Association-Responder (SAr), Traffic Selector-Initiator (TSi) and Traffic Selector-Responder (TSr). When the UE 100 receives the IKE_AUTH response message, it verifies the AUTH payload sent by the PDG 130 using PDG 130's certificate and establishes the IPSec SA.

Step 308 represents an alternative to step 303. In step 308, the UE 100 may intimate the PDG 130 to use a TSK by including the Notify payload of IKEv2 or the Vendor ID payload of IKEv2 with the AUTH payload in the IKE_AUTH request message. Here, the AUTH payload is calculated using the derived TSK as described in step 303. Further, as with step 303, the IKE_AUTH request message may include an IDi, [CERTREQ], SAi, TSi and TSr.

Step 309 represents an alternative to step 304. In step 309, the PDG 130 may include new Diameter/Radius AVP or the Vendor I) AVP of Diameter/Radius to intimate the AAA Server 140 to derive the TSK using the previous authentication keys. Here, as with step 304, the Access Request message may include a User ID and a W-APN.

Remaining steps 310, 311 and 312 are similar to the steps 305, 306 and 307 as explained above respectively. Even if UE 100 is directly accessing “WLAN 3GPP IP Access”, the AAA Server 140 can recognize to derive and use the TSK.

FIG. 4 is a diagram illustrating message exchanges, according to an exemplary embodiment of the invention, between the UE and the AAA Server when accessing the “WLAN 3GPP IP Access” services after “WLAN Direct IP Access” authentication. In FIG. 4, intimation of the PS access occurs during the “WLAN Direct IP Access” authentication (WLAN access authentication) to the AAA Server, so as to derive the TSK immediately. In step 401, a connection is established between the UE 100 and the WLAN 110.

In step 402, WLAN 110 sends an Extensible Authentication (EAP) Request Identity message to the UE 100. In step 403, the UE 100 sends an EAP Response Identity message and optionally may piggy-back the option of using PS service into the identity response after a null character. As an alternative to piggy-back the option, the UE 100 may use an “expanded payload” of the EAP, such as the vendor ID, to intimate that the 3GPP IP Access is performed consecutively. Further, the EAP Response Identity message may include a W-APN.

In step 404, the EAP Response Identity message is relayed by the WLAN 110 to the AAA Server 140. In step 405, after receiving the EAP Request Identity message, AAA Server 140 sends an EAP Request ANY Identity message to the UE 100 which may include a Notify request.

As an alternative to the options in step 403 of piggy-backing PS service information or including an expanded payload, when the AAA Server 140 receives the identity, it checks whether the identity is from an Interworking (I)-WLAN subscriber. If the identity is from an I-WLAN subscriber, the AAA Server 140 may then send a notification request. The purpose of the Notification request is to know whether 3GPP IP Access is performed consecutively. This Notify request payload is included in the EAP Request ANY Identity message.

In step 406, the WLAN 110 relays the EAP Request ANY Identity message to the UE 100 and may include the Notify request. In step 407, the UE 100 sends an EAP Response Identity message to the WLAN 110. The EAP Response Identity message may include a Notify response, PS access and W-APN. In step 408, the WLAN 110 then relays to the AAA Server 140 the Notify response intimating whether the 3GPP IP Access is performed consecutively in the EAP Response ANY Identity message. In step 409, the AAA Server 140 then starts the EAP-SIM/EAP-AKA procedure and authenticates the UE 100. In step 410, after authenticating the UE 100, the AAA Server 140 derives the TSK key and stores it.

The UE 100 may now initiate the tunnel establishment procedure. In step 411, the UE 100 sends an IKE_SA_INIT request to PDG 130 and in step 412 UE 100 receives an IKE_SA_INIT response from PDG 130. Thereby in steps 411 and 412, the UE 100 and the PDG 130 negotiate an IKE_SA.

In step 413, the UE directly derives the TSK and uses it to calculate the AUTH and includes the AUTH payload within the IKE_AUTH request message that is sent to the PDG 130. The IKE_AUTH request message may further include an IDi, [CERTREQ], SAi, TSi and TSr.

In step 414, when PDG 130 receives the IKE_AUTH request message from UE 100 with AUTH payload, the PDG 130 will request that AAA Server 140 derive the TSK. The request is via an Access Request message sent from PDG 130 to AAA Server 140. The Access Request message may include a User ID and a W-APN. In step 415, the AAA Server 140 passes the TSK to the PDG 130 through an Access Accept message. The Access Accept message may include keying material which may include the TSK.

In step 416, the PDG 130 using the TSK, verifies the AUTH Payload sent by the UE 100 and calculates the AUTH payload using a certificate. Then the PDG 130 sends the IKE_AUTH response message including the AUTH payload to the UE 100. The IKE_AUTH response message may further include an IDr, [CERT], SAr, TSi and TSr. When the UE 100 receives the IKE_AUTH response message, it verifies the AUTH payload sent by the PDG 130 using PDG's certificate and establishes the IPSec SA.

Step 417 represents an alternative to step 413. In step 417, the UE 100 may intimate the PDG 130 to use a TSK by including the Notify payload of IKEv2 or the Vendor ID payload of IKEv2 with the AUTH payload in the IKE_AUTH request message. Here, the AUTH payload is calculated using the derived TSK as described in step 413. Further, as with step 413, the IKE_AUTH request message may include an IDi, [CERTREQ], SAi, TSi and TSr.

Step 418 represents an alternative to step 414. In step 418, the PDG 130 may include new Diameter/Radius AVP or the Vendor ID AVP of Diameter/Radius to intimate the AAA Server 140 to derive the TSK using the previous authentication keys. Here, as with step 414, the Access Request message may include a User ID and a W-APN.

Remaining steps 419 and 410 are similar to the steps 415 and 416 as explained above respectively.

An exemplary embodiment of the present invention provides a mechanism to derive a new key for IKEv2 mutual authentication without performing a complete authentication procedure. Instead, a key for subsequent tunnel establishment procedure is used that was derived during a previous authentication procedure.

Further, an exemplary embodiment of the present invention provides intimation to the AAA Server to derive a new key for IKEv2 mutual authentication without performing an EAP authentication procedure. Instead, a key derived during the previous authentication procedure is used for the new tunnel establishment procedure.

Additionally, an exemplary embodiment of the present invention provides a mechanism to derive a TSK for IKEv2 mutual authentication, by using an EMSK derived during a previous authentication procedure and other parameters.

Still Further, an exemplary embodiment of the present invention provides a mechanism by which the UE intimates the AAA Server to derive a new key for IKEv2 mutual authentication by using the EMSK derived during the previous authentication procedure for a subsequent tunnel establishment procedure.

Another exemplary embodiment of the present invention provides for the generation of a TSK for IKEv2 mutual authentication, when a UE requests for different “WLAN 3GPP IP accesses” consecutively or when the UE requests for “WLAN 3GPP IP access” after “WLAN Direct IP Access” authentication consecutively.

An additional exemplary embodiment of the present invention provides intimation of the AAA Server to generate the TSK for the IKEv2 mutual authentication during the tunnel establishment procedure. This procedure can be considered for the two cases. In the first case, the AAA Server is intimated to derive the TSK during subsequent tunnels, such as when “WLAN Direct IP Access” and “WLAN 3GPP IP access” are requested independently. In this case TSK is not generated during the “WLAN Direct IP Access” authentication procedure. In the second case, intimation of the “WLAN 3GPP IP Access” occurs during the “WLAN Direct IP Access” authentication to the AAA Server, to derive a TSK immediately.

Accordingly, exemplary embodiments of the present invention comprise a system and method for optimizing the Tunnel establishment procedure in 3G-WLAN Interworking System.

Accordingly, exemplary embodiments of the present invention further comprise a method to derive a key for IKEv2 mutual authentication during WLAN 3GPP IP Access by using an EMSK derived during previous authentication procedure.

Accordingly, exemplary embodiments of the present invention further comprise a method to intimate the AAA Server by the PDG, to derive and pass a TSK during a tunnel establishment procedure or alternatively to intimate the AAA Server by the PDG, to derive and store the TSK during an WLAN Direct IP access authentication procedure.

Accordingly, exemplary embodiments of the present invention further comprise a method to intimate the PDG by the UE, to use the TSK during a tunnel establishment procedure.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for optimizing a current tunnel authentication for an interworking system comprising User Equipment (UE), (Wireless Local Area Network (WLAN), Packet Data Gateway (PDG) and Authentication, Authorization and Accounting (AAA) Server, wherein the UE has been previously authenticated by the AAA Server, the method comprising:
intimating the AAA Server to derive a Tunnel Session Key (TSK) for a current tunnel establishment request.

2. The method of claim 1, wherein the TSK is derived using an Extended Master Session Key (EMSK) derived during the previous authentication.

3. The method of claim 1, wherein the previous authentication comprises at least one of a prior tunnel authentication and a prior WLAN access authentication not performed for a current tunnel establishment request.

4. The method of claim 3, wherein the TSK is derived after the current tunnel authentication begins.

5. The method of claim 3, wherein upon deriving the TSK, the AAA Server sends the TSK to the PDG.

6. The method of claim 1, wherein the previous authentication comprises a WLAN access authentication performed for a current tunnel establishment request.

7. The method of claim 6, wherein the TSK is derived after the WLAN access authentication but before current tunnel authentication begins.

8. The method of claim 6, wherein upon deriving the TSK, the AAA Server stores the TSK.

9. The method of claim 6, wherein the AAA Server sends the TSK to the PDG after the current tunnel authentication begins.

10. The method of claim 1, wherein the UE sends an authentication request message to the PDG comprising an Authentication (AUTH) payload calculated using a UE derived TSK.

11. The method of claim 10, wherein the UE intimates the PDG to use a TSK by including a Notify payload or Vendor Identification (ID) payload in the authentication request message.

12. The method of claim 10, wherein the PDG, after receiving the authentication request message, sends an access request message to the AAA Server to request the TSK.

13. The method of claim 12, wherein the access request message comprises at least one of a new Diameter/Radius AVP and the Vender ID AVP of a Diameter/Radius to intimate the AAA Server.

14. The method of claim 12, wherein the AAA Server, after receiving the access request message, sends an access accept message to the PDG, the Access Accept message comprising the derived TSK;
wherein the PDG, using the TSK, verifies the AUTH payload sent by the UE and calculates the AUTH payload using a certificate;
wherein the PDG sends an authentication response message to the UE, the authentication response message comprising the AUTH payload; and
wherein the UE receives the authentication response message, verifies the AUTH payload using the certificate and establishes an Internet Protocol Security Protocol Security Association (IPSec SA).

15. The method of claim 6, wherein during the WLAN access authentication, the UE sends an EAP message to the WLAN that is relayed to the AAA Server; and
wherein the EAP message comprises piggy-backed Packet Switched (PS) service information or an extended payload so as to intimate the current tunnel establishment request.

16. The method of claim 6, wherein during the WLAN access authentication, the UE sends an EAP message to the WLAN that is relayed to the AAA Server;
wherein the AAA Server checks to see if UE is associated with an interworking WLAN subscriber, and if so the AAA Server sends a notification request that is relayed by the WLAN to the UE; and
wherein the notification request is at least partially used for determining if there is a current tunnel establishment request.

17. The method of claim 16, wherein the UE, upon receiving the notification request, sends a notification response message that is relayed via the WLAN or the AAA Server so as to intimate the current tunnel establishment request.

18. A system for optimizing a current tunnel authentication, the system comprising:
an interworking system comprising a UE, WLAN, PDG and AAA Server, wherein the UE has been previously authenticated by the AAA Server, and further wherein the AAA Server is intimated to derive a TSK for a current tunnel establishment request.

19. The system of claim 18, wherein the previous authentication comprises at least one of a prior tunnel authentication and a prior WLAN access authentication not performed for a current tunnel establishment request.

20. The system of claim 18, wherein the previous authentication comprises a WLAN access authentication performed for a current tunnel establishment request.

21. The system of claim 18, wherein the TSK is derived using an EMSK derived during the previous authentication.
